(19) United States
(12) Patent Application Publication
(10) Pub. No.: US 2010/0055662 A1
(43) Pub. Date: Mar. 4, 2010

(54) GROWTH/ACHIEVEMENT DATA VISUALIZATION SYSTEM

(75) Inventor: Damian Betebenner, Brookline, MA (US)

Correspondence Address: MESMER & DELEAULT, PLLC, 1 NEW HAMPSHIRE AVE., SUITE 125, PORTSMOUTH, NH, 03801, US

(73) Assignee: National Center for the Improvement of Educational Assessment, Inc., Dover, NH (US)

(21) Appl. No.: 12/546,160

(22) Filed: Aug. 24, 2009

Related U.S. Application Data
(60) Provisional application No. 61/092,909, filed on Aug. 29, 2008.

(51) Int. Cl. G09B 29/00

(52) U.S. Cl. 434/430

(57) ABSTRACT

A method and system that presents a high amount of relevant information related to schools, students, subject, assessment scores, grade level, gender, and ethnicity in a clear and coherent manner, yet is cross referenced for easy access to related information. The method and system is built using a database loaded with student and school data, a plurality of available information screens that plot achievement versus growth for selected data sets, plus screens that plot individual students' achievement timely through their grade levels.

### BACKGROUND

1. Field of the Invention

The invention relates to a method and system for presenting state, district, school, student subgroup and individual student data using optimized interactive graphical representations on a computer.

2. Description of the Related Art

One cannot achieve what one does not measure. Communities are demanding that students and schools achieve at least minimum levels of proficiency in several academic subjects. To measure proficiency, students are tested. This testing produces data that can be analyzed and used to understand the performance of students and schools. These data can be used to make comparisons amongst students, amongst schools, amongst other grades, and amongst other ethnic groups in each of the different academic subjects in terms of both achievement and growth.

Groups of schools in general and school districts in particular, are responsible for allocating their budgets to achieve the goals of at least minimum proficiency. They need to focus on the problem areas and learn from the successful areas. There is so much data at the state, district and school level, however, it is difficult for administrators to grasp the details and the big picture of school performance at the same time as looking at the smaller picture of individual student performance. However, they must grasp the details and the big picture if they are to make the important decisions that directly affect the success of schools and students.

There is a need, therefore, to develop a method or system that presents a high amount of relevant information without clouding one's understanding with less important details. Yet the same method or system must be cross referenced so that a user can easily drill down to individual grades, gender, subject, ethnicity, schools, individual student scores, and their past assessment data.

### SUMMARY

The invention is a method and system that presents a high amount of relevant information related to schools, students, subject, assessment scores, grade level, gender, and ethnicity in a clear and coherent manner, yet is cross referenced for easy access to related information. The data visualization tool submitted is a graphical user interface allowing the user to examine education quality along two dimensions (growth and achievement), across various levels of the education system (individual student, class, school, and district), and in terms of various sub-groupings (e.g., student ethnicity or gender). The growth dimension represented in the data tool utilizes student growth percentiles at the individual and group level (aggregated) to represent growth. These and other features, aspects, and advantages of the present invention will become better understood with regard to the following description, claim, and accompanying drawings.

### DRAWINGS

FIG. 1 is a growth versus achievement chart that plots growth and achievement results for individual schools.

FIG. 2 is a growth versus achievement chart that plots individual grades within individual schools.

FIG. 3 is a growth versus achievement chart comparing individual students within one grade of one school.

FIG. 4 is an achievement time line of a single student through many grades compared against a background of criterion referenced state standards represented as color bands.

FIG. 5 is a growth versus achievement chart that plots the ethnic group achievement within one grade among all schools in a school district.

### DESCRIPTION

The invention is a method for presenting academic performance information on a computer for groups of schools, for example, a school district. The method presents a great deal of highly relevant information on particular screens from which it is easy to go to other cross-referenced screens with related information. The content of some of the screens are selected to give the school administration information charted by school, grade, gender, ethnicity, and academic subject on the scales of growth, achievement, and proficiency. The information is cross-referenced to individual student information that charts each student's performance in each grade and in each subject within the grade.

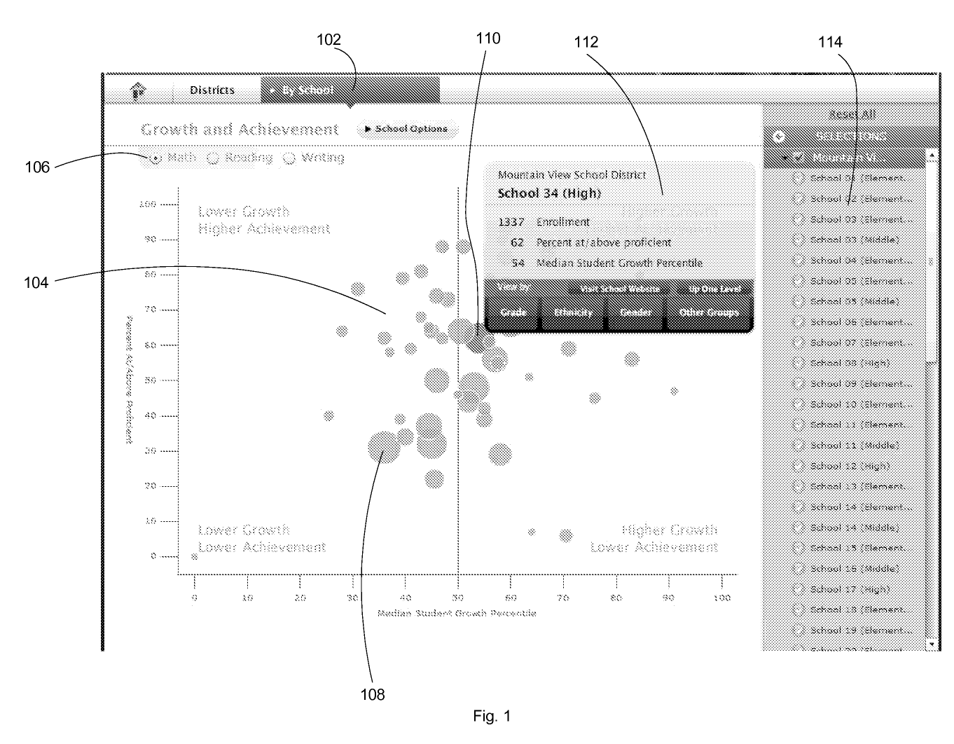

Turning to FIG. 1, a user would typically enter the system on a top level screen that shows all schools in the group, which is typically a school district. A crumb trail bar 102 is in the upper left. A subject bar 106 can be used to change the display to present one or all the academic subjects. When the user is looking at plots under a particular subject matter, the data points may have a different color to distinguish the different subjects from each other.

An X-Y school bubble plot 104 presents the measured performance in terms of the growth and achievement of the students in the individual schools 108. This school bubble plot 104 has an X axis that represents median student growth percentile, extending from low growth versus high growth schools, dividing them at the 50^{th} median growth percentile state average line. The Y axis presents the schools that have a particular percent of students at or above proficient for a selected subject. A horizontal line at the Y axis is set, in this particular state, at 66% as the division between low achievement and high achievement. It can be appreciated by those familiar with academic performance data that this invention is not limited to these particular figures or metrics, and that equivalent measures could be used. For example, the vertical axis could depict percent of student above (or below) any state defined threshold (e.g., unsatisfactory). Similarly, the horizontal axis could depict the percentage of students demonstrating adequate growth to reach the state defined proficiency threshold.

If one rolls the cursor over a particular school 110, a data tip 112 is produced with a menu of information describing the data point and options the user can select from. In this case, it shows the school name and the menu of whether to see detailed information presented by grade, gender, or ethnicity.

Each circle in the group of individual schools 108 represents an individual school. The relative size of the school enrollment is represented by the relative size of the circle, which is a chart format commonly known as a bubble chart. This relationship in circle sizes carries over to other screens as well.

The individual schools are listed in a panel on the right 114 that has a list rollover functionality. Rolling over a school in the right hand panel 114 would produce a pop up menu of information, like the school bubble menu 112. There is more than one way to get the same information.

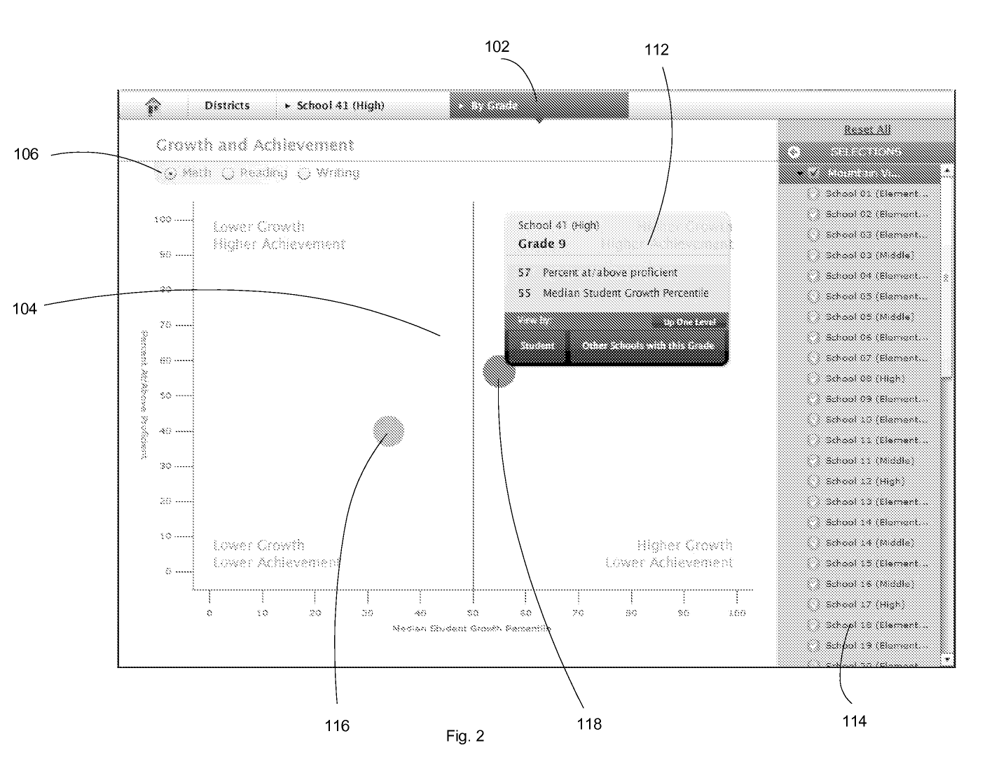

For example, if one selected “by grade” within the school bubble menu 112 of a particular school, the screen would change to that shown in FIG. 2. In FIG. 2, note that the crumb trail bar 102 has been extended because the user has gone deeper into the information, namely, a breakdown within the school. By clicking on an earlier tab in the crumb trail bar 102, one can get back to a previous screen.

In FIG. 2, the scatter chart 104 grid is the same. Each grade 116 in the particular school is shown in its charted position of growth versus achievement for the subject matter selected in the subject bar 106. The right panel 114 has changed to present a list of schools. The size of the circles of each grade 116 is related to the size of the population in each grade. Rolling over an individual grade 118 within the individual school produces a grade bubble menu 112. This grade bubble menu 112 gives the user the option to view students with the subject and grade and other schools in the grade for the subject.

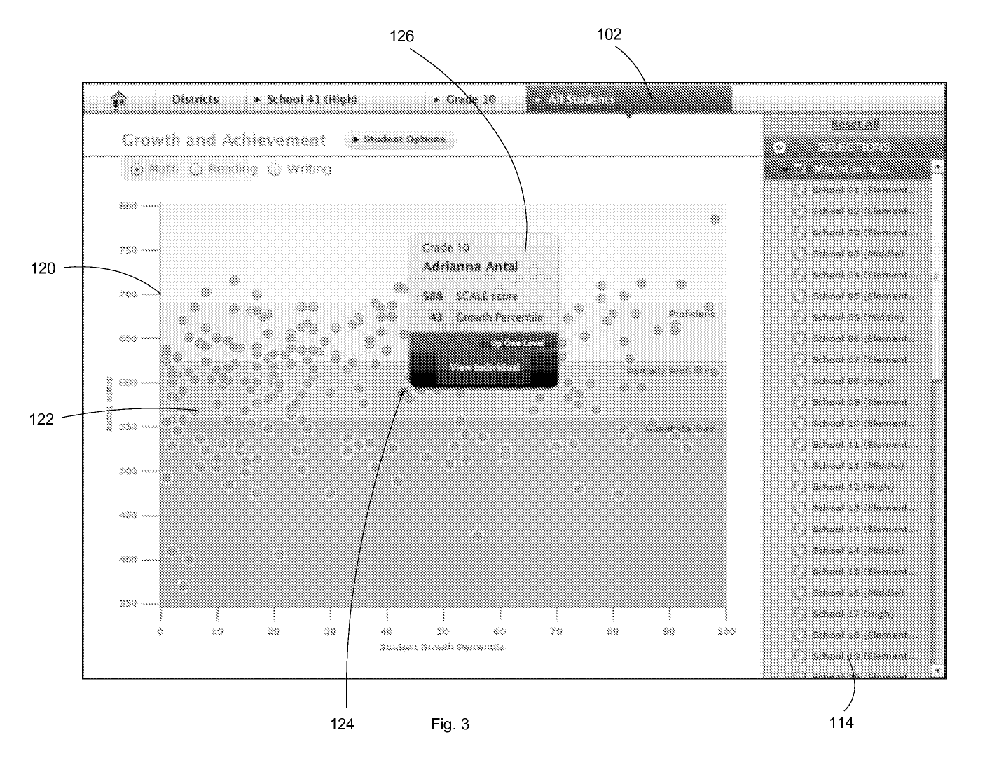

For example, if the user then selects “view by student” in the grade bubble menu 112 of FIG. 2, the screen would change to that shown in FIG. 3. FIG. 3 shows the relative achievement of individual students within a particular school, grade, and subject in a student scatter plot 120. Once again, the crumb trail bar 102 has been extended with the additional information. The right side panel 114 lists the schools. However, the student scatter plot 120 presents data a different way. The student scatter plot presents each individual student 122 according to the student growth percentile on the X axis ranging from the zero to one hundred percentile. The students' scale score is on the Y axis. The scale score could be the score on any state administered assessment or, for example, a nationally standardized test, such as the scholastic aptitude test (“SAT”) for example.

If the user places the cursor over a dot 124 that represents an individual student, a bubble menu 126 appears with the student's name, subject, and the option to view the student's information across multiple categories.

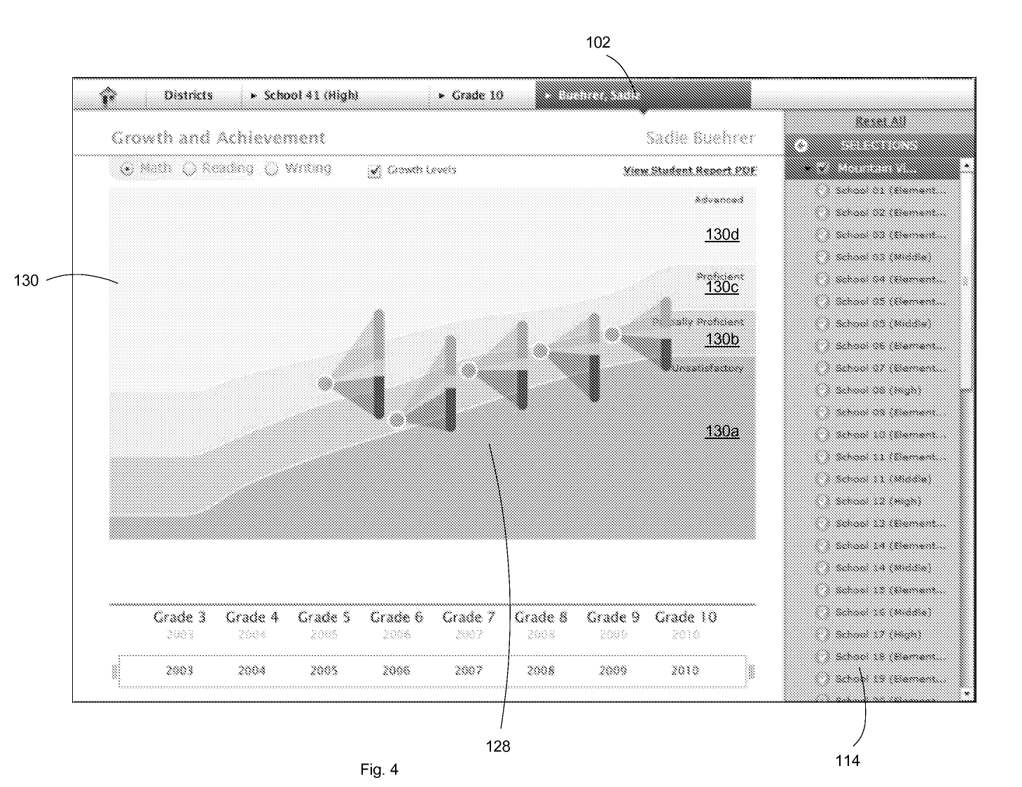

For example, if the user selects “view individual” in the bubble menu 126 of FIG. 3, the screen would change to that shown in FIG. 4. Once again, the crumb trail bar 102 has changed. The right panel 114 remains unchanged. However, the population 128 in the achievement scatter plot 130 has changed to indicate the student's achievement in the subject over time over different grades.

Furthermore, the achievement scatter plot 130 in FIG. 4 presents information in a completely new way. It is an achievement timeline. The X axis represents the student's current and/or past grade levels. The Y axis has the student's scale score. However, the plot 130 also presents the student's standing for each grade and subject within zones/colored regions established by criterion referenced performance levels across all grades tested, in this case established by the state. For example, the zones/colored regions could be unsatisfactory 130a, partially proficient 130b, proficient 130c, and advanced 130d. The performance levels are established separately for each grade, and can vary in number from 2 (e.g., unsatisfactory/satisfactory) up to more than 10.

Like with the other screens, the crumb trail bar 102 has been updated, and the right hand panel 114 shows relevant information. If the user places the cursor over a student's particular grade, a relevant bubble menu is presented that reveals the student's name, school, grade, subject, and score for that subject. This achievement timeline screen of FIG. 4 may also present individual student data and a photo of the student.

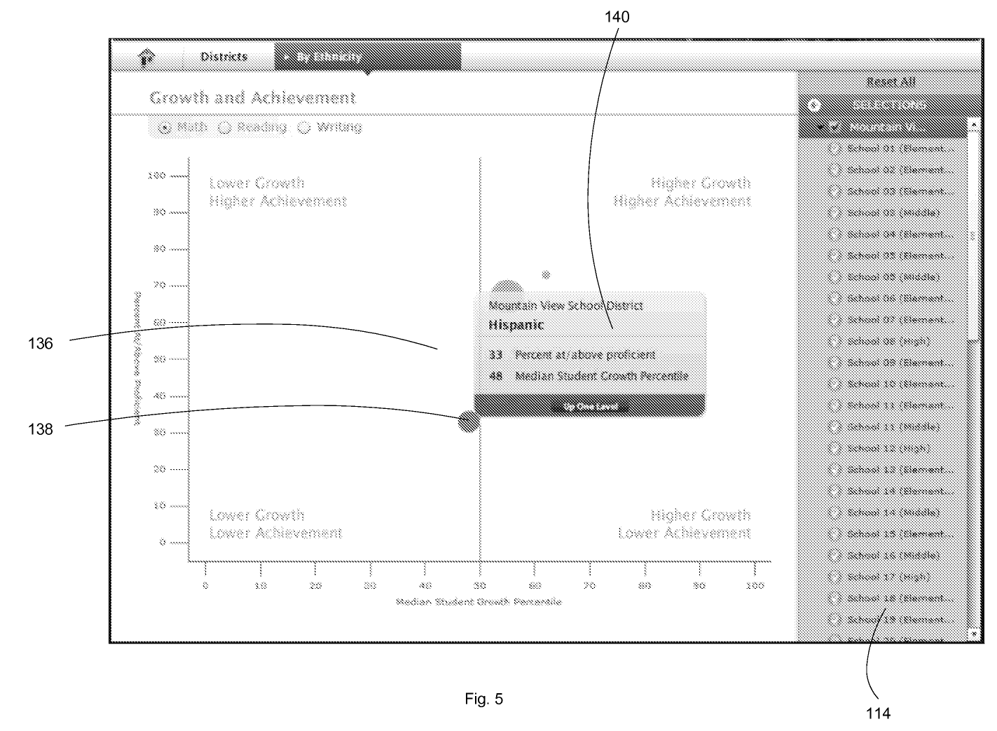

Because the information is all cross-referenced, one can look at the information from nearly any angle. FIG. 5 shows the screen that is displayed when a group's ethnicity is selected from a bubble menu. The ethnic groups present and relative performance are shown in the population 136 in the ethnicity bubble chart. The size of the dots is related to the size of the ethnic group within the district, or group of schools. For example, if one places the cursor over one dot 138, the ethnic group is displayed in a bubble menu 140. A list of schools is presented in the right hand panel 114, so a user can discover the ethnic makeup of each school by clicking on them.

In practice, the system may be provided on any of a number of different computer platforms. It can be provided as a web site that users can log on to remotely. It can also be ported to a cross-platform system that behaves like a web browser such as that provided by Adobe AIR®.

The information can be presented in paper, but it is most useful to use a computer because of the ability for viewing data from different perspectives more easily. The method of presenting the academic performance data can be performed by providing software stored on a computer-readable medium. The information can be displayed on a computer display. The word “page” as used herein can refer to a paper page or the image present on a computer display screen. The benefit of using the computer method is that links to other pages can clicked for navigating to them, greatly facilitating the understanding of complex sets of information.

The system provides a powerful graphical tool for school administrators to find the groups and the students that are demonstrating high and low achievement and/or growth. It is necessary so that the administrators can focus attention and the districts resources where and to whom it is needed the most.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method for presenting student academic performance data using academic test data comprising the steps of:
presenting an achievement scatter plot with an X axis and a Y axis, the X axis presenting a student's current or past grade levels and the Y axis presenting a student's scale score in each grade level for a selected academic subject; and
presenting the student's standing in the same plot on the same page as the achievement scatter plot in each grade level using zones established by referenced performance levels.

2. The method of claim 1 wherein four performance level zones are presented, representing advanced, proficient, partially proficient, and unsatisfactory performance.

3. The method of claim 1, further comprising the step of presenting a bubble menu for a student's score for a selected grade on the same page as the scatter plot, the bubble menu presenting the student's name, school, grade, subject, and score for that subject.

4. The method of claim 3, the bubble menu further presenting a photo of the student.

5. The method of claim 1, further comprising the step of presenting the academic subject on the same page as the achievement scatter plot.

6. The method of claim 1, further comprising the step of presenting a crumb trail bar on the same page as the achievement scatter plot, the crumb trail bar indicating the student's name and school.

7. The method of claim 1, further comprising the step of presenting a list of schools on the same page as the crumb trail bar and achievement scatter plot.

8. The method of claim 1, further comprising the step of presenting a school bubble plot on a different page than that of the achievement scatter plot, the school bubble plot having an X axis presenting median student growth percentile and the Y axis presenting the percent of students at or above proficiency for a selected subject at a school shown by a school bubble, the size of the school bubble presenting the relative student population in the school.

9. The method of claim 8 further comprising the step of presenting a data tip associated with a particular school, the data tip presenting the school name, population, and options to select grade, ethnicity, gender, and other groups.

10. The method of claim 9, further comprising the steps of:
presenting a list of schools on the same page as the school bubble plot that can be selected; and
presenting a crumb trail bar.

11. The method of claim 9 further comprising the step of presenting a grade bubble plot on a different page than that of the school bubble plot and achievement scatter plot, the grade bubble plot having an X axis presenting median student growth percentile and a Y axis presenting the percent of students at or above proficiency for a selected subject at a grade shown by a grade bubble, the size of the grade bubble presenting the relative student population in the grade at the selected school.

12. The method of claim 11, further comprising the step of presenting a bubble menu for a grade's score for a selected grade on the same page as the grade bubble plot, the bubble menu presenting the school name, grade, and score for a selected subject.

13. The method of claim 12, further comprising the step of presenting a student scatter plot on a different page than that of the school bubble plot, grade bubble plot, and achievement scatter plot, the student scatter plot having an X axis presenting student growth percentile and a Y axis presenting a scale score for each student in a selected grade and selected subject.

14. The method of claim 13, further comprising the step of presenting a bubble menu for a student's scale score for a selected grade on the same page as the student scatter plot, the bubble menu presenting the student name, grade, scale score, and growth percentile for the selected student, grade, and subject.

15. The method of claim 1, further comprising the step of presenting an ethnicity bubble chart on a different page from the school bubble plot and achievement scatter plot, the ethnicity bubble chart having an X axis presenting median student growth percentile and having a Y axis presenting the percentage of the population at or above proficient for each ethnic group present in a selected grade, school, and subject.

16. A method for presenting student academic performance data using academic test data on a single computer display page comprising the steps of:
providing software stored on a computer-readable medium for presenting information on a computer display;
presenting a scatter plot on the computer display with an X axis and a Y axis, the X axis presenting a student's current or past grade levels and the Y axis presenting a student's scale score in each grade level for a selected academic subject;
presenting the student's standing in the same plot in each grade level using zones established by referenced performance levels; and
presenting selectable academic subjects in a list that changes to the student's scale score in a different academic subjects when the subject is selected.

17. The method of claim 16, further comprising the steps of:
presenting a school bubble plot on a different page than that of the achievement scatter plot, the school bubble plot having an X axis presenting median student growth percentile and the Y axis presenting the percent of students at or above proficiency for a selected subject at a school shown by a school bubble, the size of the school bubble presenting the relative student population in the school; and
presenting a data tip associated with a particular school, the data tip presenting the school name, population, and options to select grade, ethnicity, gender, and other groups.

18. The method of claim 17, further comprising the steps of:
presenting a grade bubble plot on a different page than that of the school bubble plot and achievement scatter plot, the grade bubble plot having an X axis presenting median student growth percentile and a Y axis presenting the percent of students at or above proficiency for a selected subject at a grade shown by a grade bubble, the size of the grade bubble presenting the relative student population in the grade at the selected school; and
presenting a bubble menu for a grade's percentile for a selected grade on the same page as the grade bubble plot, the bubble menu presenting the school name, grade, and percentile, and options to view by student and other schools with that grade for a selected subject.

19. The method of claim 18, further comprising the steps of:
presenting a student scatter plot on a different page than that of the school bubble plot, grade bubble plot, and achievement scatter plot, the student scatter plot having an X axis presenting student growth percentile and a Y axis presenting a scale score for each student in a selected grade and selected subject; and
presenting a bubble menu for a student's scale score for a selected grade on the same page as the student scatter plot, the bubble menu presenting the student name, grade, scale score, and growth percentile for the selected student, grade, and subject; and option to view individual.

20. The method of claim 16, further comprising the steps of:
presenting an ethnicity bubble chart on a different page from the school bubble plot and achievement scatter plot, the ethnicity bubble chart having an X axis presenting median student growth percentile and having a Y axis presenting the percentage of the population at or above proficient for each ethnic group present in a selected grade, school, and subject; and
presenting a bubble menu for a school's ethnicity and proficiency percentile in a selected subject, and options to go up one level.
